(19) United States
(12) Patent Application Publication
(10) Pub. No.: US 2023/0054500 A1
(43) Pub. Date: Feb. 23, 2023

(54) FASTENER STRUCTURE CONFIGURED TO BE LOCKED SLANTINGLY SO AS TO PROVIDE EFFECTIVE AND STABLE ELECTRICAL CONDUCTION

(71) Applicant: UltiPros Technology Co., Ltd., Taoyuan City (TW)

(72) Inventor: Yung-Hua CHANG, Taoyuan City (TW)

(73) Assignee: UltiPros Technology Co., Ltd.

(21) Appl. No.: 17/499,452

(22) Filed: Oct. 12, 2021

(30) Foreign Application Priority Data
Aug. 20, 2021 (TW) 110209849

(51) Int. Cl. F16B 39/34; F16B 39/30

(52) U.S. Cl. CPC F16B 39/34; F16B 39/30

(57) ABSTRACT

A fastener structure configured to be locked slantingly so as to provide effective and stable electrical conduction can be used to lock a to-be-locked object in place. The fastener structure includes a rod body and at least two inclination adjustment units. The rod body has a thread portion. The at least two inclination adjustment units are offset from each other and are formed on different surface portions of the rod body that are at different heights of the rod body respectively, such that the thread portion is left with an exposed surface portion. The at least two inclination adjustment units allow the rod body to be locked slantingly in the to-be-locked object, with the exposed surface portion of the thread portion in close contact with the thread of the threaded hole of the to-be-locked object to enable effective and stable electrical conduction.

### BACKGROUND OF THE INVENTION

### 1. Technical Field

The present invention relates to a fastener structure configured to be locked slantingly so as to provide effective and stable electrical conduction. More particularly, the invention relates to a fastener structure that is configured to be locked slantingly in, and thereby couple together, different objects so as to provide effective and stable electrical conduction between the objects.

### 2. Description of Related Art

Threaded fasteners such as screws are employed in modernized industries as well as in products for daily use. In addition to facilitating manufacture and assembly and providing structural safety, some screws are required to provide electrical conduction in order to meet functional or safety requirements, e.g., to be part of a grounding circuit, to transmit communication signals, or to help remove static electricity. Consequently, threaded fasteners capable of providing effective and stable electrical conduction have become essential products.

FIG. 1 shows a conventional screw structure P10 whose standard thread P110 is locked in a to-be-locked object P20. While the screw structure P10 is electrically conductive, the contact between the standard thread P110 and the thread P210 of the threaded hole may become unstable, or the threads may separate from each other, when the to-be-locked object P20 is subjected to vibrations or when the screw structure P10 is not securely tightened, thus resulting in unstable, if not ineffective, electrical conduction.

As a solution, the threaded fastener industry has developed the deformed thread P111 as shown in FIG. 2, the objective being to enhance the contact between the deformed thread P111 and the thread P210 of the threaded hole and thereby prevent unstable electrical conduction caused by vibrations. The deformed thread P111, however, is not of standard thread specifications, is difficult to make, and cannot be used repeatedly. Moreover, the deformed thread P111 requires expensive manufacturing equipment and material, has a low production yield due to its difficult manufacturing process, and entails a relatively long production time. All of the aforesaid disadvantages lower the economic benefit of a product with such a thread.

### BRIEF SUMMARY OF THE INVENTION

The present invention provides a fastener structure that is designed to be locked slantingly so as to provide effective and stable electrical conduction. The primary objective of the invention is to enable a standard thread to provide the same level of effectiveness and stability of electrical conduction as does a deformed thread, thereby preventing the afore-mentioned problems of a deformed thread, such as the required use of expensive manufacturing equipment, a low production yield, low production efficiency, and the high selling price of a deformed-threaded fastener.

The present invention provides a fastener structure that is configured to be locked slantingly so as to provide effective and stable electrical conduction. The fastener structure can be used to lock a to-be-locked object in place and includes a rod body and at least two inclination adjustment units. The rod body has a slender shaft portion and a thread portion formed on the surface of the shaft portion. The rod body also has an inserting end portion and a terminal portion. The at least two inclination adjustment units are formed on the rod body at different heights thereof respectively, are offset from each other, and partially cover the surface of the thread portion, leaving the thread portion with an exposed surface portion. Thanks to the at least two inclination adjustment units, the rod body can be locked slantingly in the to-be-locked object, with the exposed surface portion and the to-be-locked object in metal-to-metal contact with each other.

Implementation of the present invention can produce at least the following advantageous effects:
1. A standard thread can provide a threaded fastener with the same level of effectiveness and stability of electrical conduction as does a deformed thread.
2. A threaded fastener having the function of a costly deformed thread can be produced at low cost.
3. The resulting threaded fastener can be used repeatedly, locked with ease, and obtained without difficulty.
4. A threaded fastener of a new deformed configuration can be produced at low cost, with a high production yield and high production efficiency, and without using expensive manufacturing equipment.
5. Effective and stable electrical conduction can be achieved.

### BRIEF DESCRIPTION OF THE SEVERAL VIEWS OF THE DRAWINGS

The structure and the technical means adopted by the present invention to achieve the above and other objects can be best understood by referring to the following detailed description of the preferred embodiments and the accompanying drawings, wherein:

FIG. 1 is a sectional view showing how a conventional fastener with a standard thread is locked in a to-be-locked object;

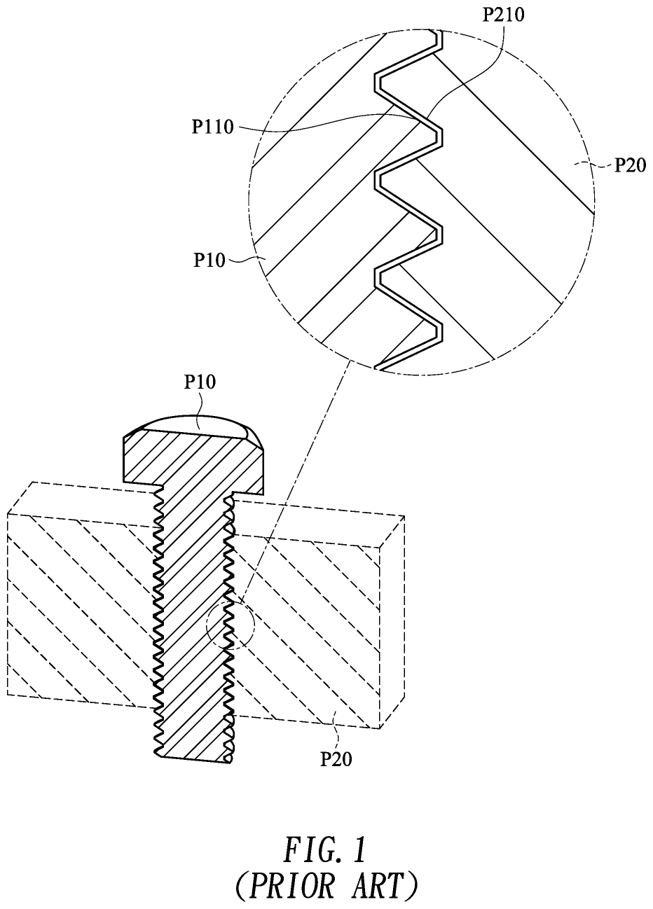

FIG. 2 is a sectional view showing how a conventional fastener with a deformed thread is locked in a to-be-locked object;

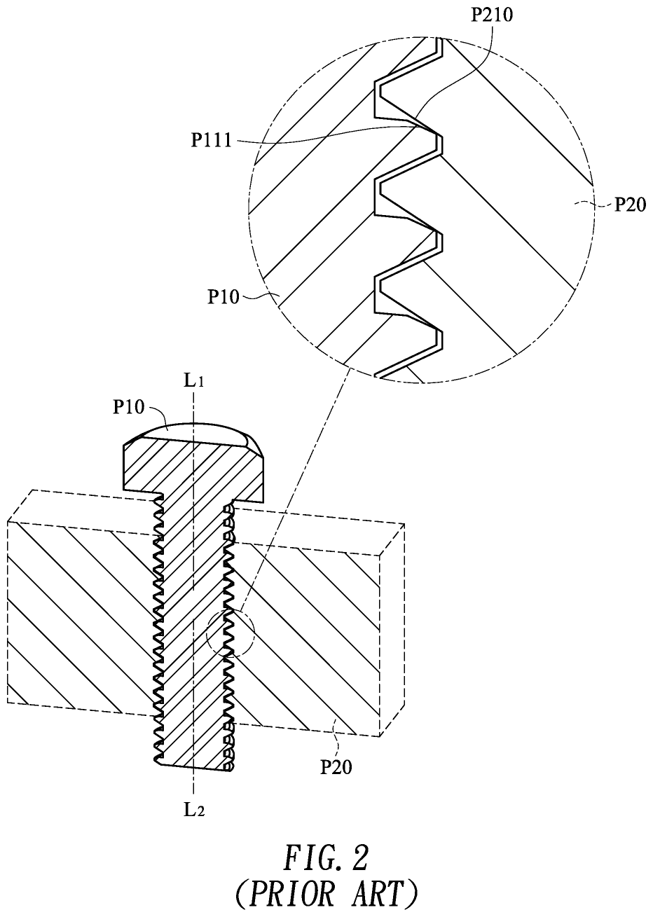

FIG. 3 is a perspective view of a fastener structure according to the present invention, wherein the fastener structure is configured to be locked slantingly so as to provide effective and stable electrical conduction;

FIG. 4 is a sectional view showing how a fastener structure according to the invention is locked slantingly in a to-be-locked object;

FIG. 5 is a sectional view showing, in particular, inclination adjustment units of different thicknesses;

FIG. 6 is a perspective view showing, in particular, inclination adjustment units with different coverage areas;

FIG. 7 is a top view of the fastener structure in FIG. 3, showing that the inclination adjustment units are arranged symmetrically on the circumferential surface of the rod body; and

FIG. 8 is an exploded perspective view of the fastener structure in FIG. 7 (i.e., in FIG. 3).

### DETAILED DESCRIPTION OF THE INVENTION

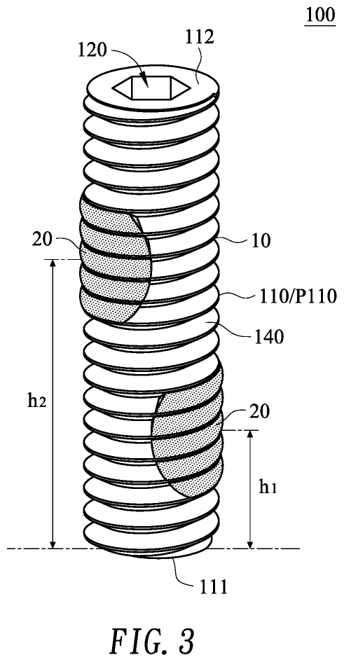

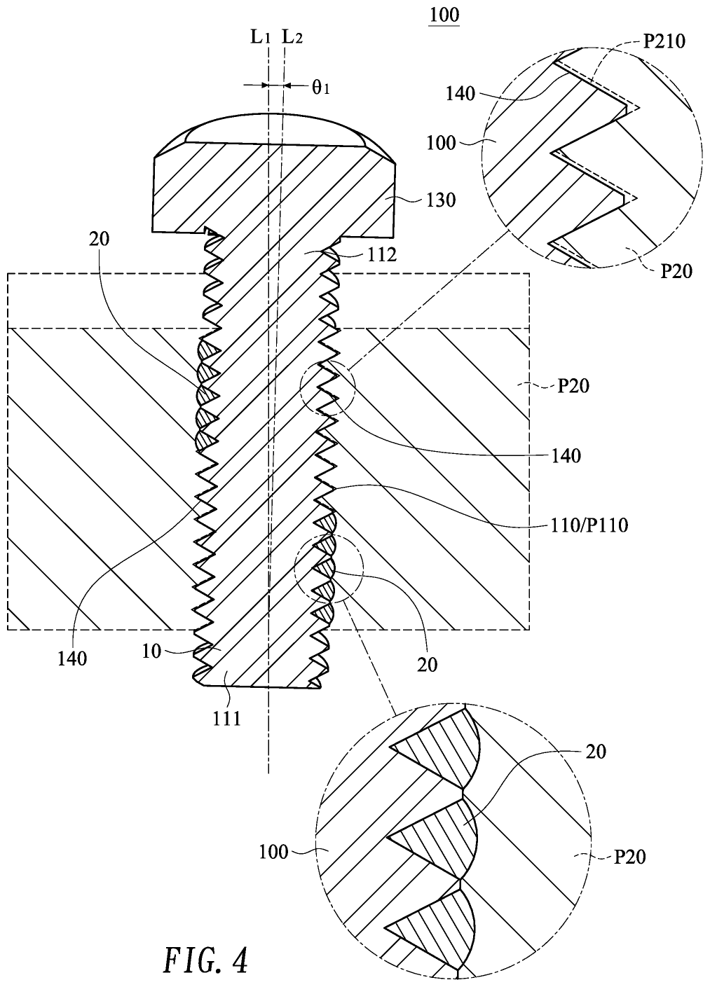

Referring to FIG. 3 and FIG. 4, the fastener structure 100 according to an embodiment of the present invention is configured to be locked slantingly so as to provide effective and stable electrical conduction. The fastener structure 100 can be used to lock a to-be-locked object P20 in place and includes a rod body 10 and at least two inclination adjustment units 20. Once the fastener structure 100 is locked in a threaded hole of the to-be-locked object P20, the center line Li of the standard thread of the fastener structure 100 and the center line L2 of the thread of the threaded hole of the to-be-locked object P20 form an inclination angle θ₁ therebetween.

The rod body 10 is, for example, the threaded shaft of a screw. The rod body 10 has a slender shaft portion and a thread portion 110. The thread portion 110 is formed on the surface of the shaft portion and has a standard thread P110. The rod body 10 also has an inserting end portion 111 and a terminal portion 112.

To facilitate operation of the rod body 10 so that an intended locking operation can be carried out with ease, the terminal portion 112 may have a polygonal recess 120 (such as a polygonal recess 120 matching a hex key in shape) or be extended with a head portion 130 (such as a screw head matching the opening of a wrench in shape or a screw head to be driven with a flat-bladed or cross-head screwdriver).

The at least two inclination adjustment units 20 are formed on the rod body 10 at different heights of the rod body 10 respectively and are offset from each other. For example, the at least two inclination adjustment units 20 are essentially a thread-locking adhesive and are formed by applying the adhesive over an upper portion and a lower portion of the rod body 10 that are not vertically aligned, such that the center points of the at least two inclination adjustment units 20 are at a first height h1 and a second height h2 of the rod body 10 respectively. When the rod body 10 is locked in the to-be-locked object P20, the at least two inclination adjustment units 20 not only keep the rod body 10 from getting loose, but also allow the rod body 10 to provide effective and stable electrical conduction.

The at least two inclination adjustment units 20 are offset from each other in such a way that they are spaced apart by, for example, at least one thread pitch. In addition, the at least two inclination adjustment units 20 cover certain surface portions of the thread portion 110, leaving the thread portion 110 with an exposed surface portion 140. The exposed surface portion 140 is intended to be in secure surface-to-surface contact with the thread P210 of the threaded hole of the to-be-locked object P20 so as to enable effective electrical conduction and prevent unstable electrical conduction attributable to vibrations.

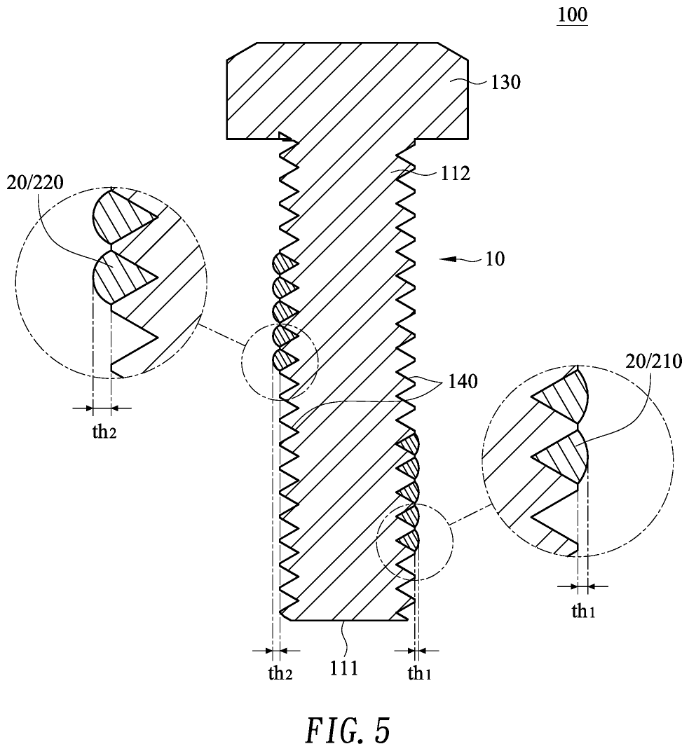

Referring to FIG. 5, the at least two inclination adjustment units 20 may be a first inclination adjustment unit 210 of a first thickness th₁ and a second inclination adjustment unit 220 of a second thickness th2. The first inclination adjustment unit 210 is adjacent to the inserting end portion 111 while the second inclination adjustment unit 220 is adjacent to the terminal portion 112.

In order to lock the rod body 10 effectively and to control the inclination angle θ₁ of the locked rod body 10 effectively, the first thickness th₁ of the first inclination adjustment unit 210 may be less than or equal to the second thickness th2 of the second inclination adjustment unit 220.

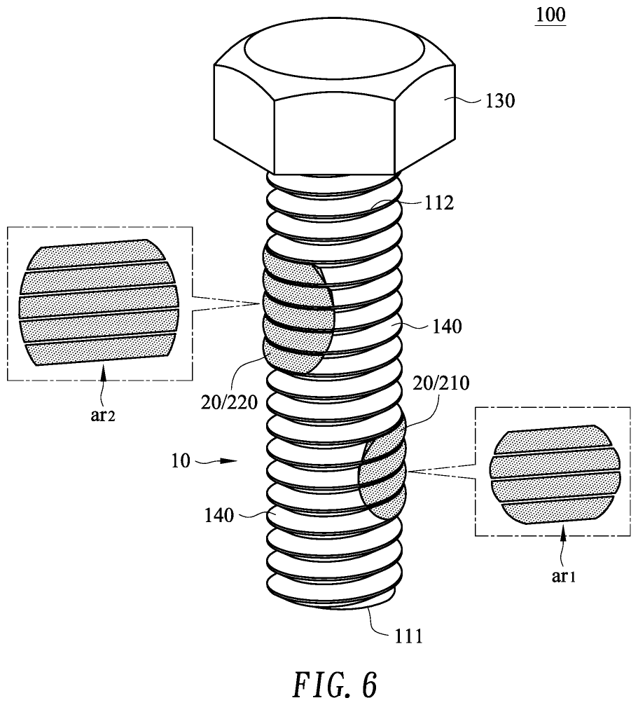

Referring to FIG. 6, the at least two inclination adjustment units 20 may also be a first inclination adjustment unit 210 having a first coverage area ar₁ and a second inclination adjustment unit 220 having a second coverage area ar2, with the first inclination adjustment unit 210 being adjacent to the inserting end portion 111 and the second inclination adjustment unit 220 being adjacent to the terminal portion 112.

In order to lock the rod body 10 effectively and to control the inclination angle of the locked rod body 10 and the thread-locking effect effectively, the first coverage area an of the first inclination adjustment unit 210 may be less than or equal to the second coverage area ar2 of the second inclination adjustment unit 220.

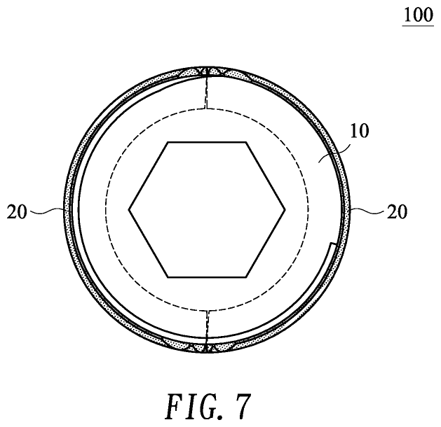

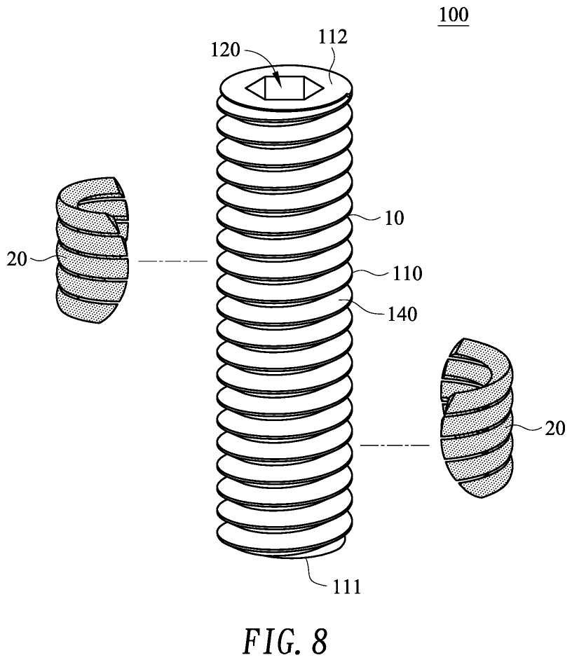

In order for the locked rod body 10 to be optimally inclined and subjected to a balanced stress, referring to FIG. 7 and FIG. 8, in which FIG. 7 is a top view of the fastener structure in FIG. 3, the at least two inclination adjustment units 20 are elliptical and are provided symmetrically on the circumferential surface of the rod body 10 such that when viewed from above the rod body 10, the center points of the at least two inclination adjustment units 20 are symmetrically located on the circumferential surface of the rod body 10.

In order to provide the inclination adjustment units 20 effectively on certain surface portions of the thread portion 110, at least one of the inclination adjustment units 20 may be a thread-locking adhesive, such as a thermoplastic or thermosetting plastic element.

The fastener structure 100 can be easily locked when the inclination adjustment units 20 are provided in an offset but symmetric manner and are respectively formed by coatings that are not too thick. The at least two inclination adjustment units 20 allow the rod body 10 to be locked slantingly in the to-be-locked object P20 and tightened in the same way as a screw with a deformed thread, with the exposed surface portion 140 of the thread portion 110 in secure surface-to-surface contact with the to-be-locked obj ect P20 to reduce impedance, enhance electrical conduction, and prevent unstable electrical conduction attributable to vibrations.

Moreover, as the rod body 10 can be locked slantingly in the to-be-locked object P20 thanks to the at least two inclination adjustment units 20, the standard thread on the rod body 10 can provide the same level of effectiveness and stability of electrical conduction as does a deformed thread. This embodiment, therefore, is practically a screw having a deformed thread and capable of being locked slantingly but allows the high production cost of a conventional screw with a deformed thread to be greatly reduced and hence the economic benefit of the end product to be increased.

The embodiments described above are intended to demonstrate the features of the present invention so that a person skilled in the art can understand the contents disclosed herein and implement the invention accordingly. The embodiments are not intended to be restrictive of the scope of the invention. Therefore, any equivalent modification or change that does not depart from the spirit of the invention shall fall within the scope of the appended claims.

The above description is only the preferred embodiments of the present invention, and is not intended to limit the present invention in any form. Although the invention has been disclosed as above in the preferred embodiments, they are not intended to limit the invention. A person skilled in the relevant art will recognize that equivalent embodiment modified and varied as equivalent changes disclosed above can be used without parting from the scope of the technical solution of the present invention. All the simple modification, equivalent changes and modifications of the above embodiments according to the material contents of the invention shall be within the scope of the technical solution of the present invention.

What is claimed is:

1. A fastener structure configured to be locked slantingly so as to provide effective and stable electrical conduction, for use to lock a to-be-locked object in place, the fastener structure comprising:
a rod body having a slender shaft portion and a thread portion formed on a surface of the shaft portion, the rod body further having an inserting end portion and a terminal portion; and
at least two inclination adjustment units formed on the rod body at different heights thereof respectively, the at least two inclination adjustment units being offset from each other and partially covering a surface of the thread portion such that the thread portion is left with an exposed surface portion;
wherein the at least two inclination adjustment units allow the rod body to be locked slantingly in the to-be-locked object such that metal-to-metal contact is established between the exposed surface portion and the to-be-locked object.

2. The fastener structure configured to be locked slantingly as claimed in claim 1, wherein the at least two inclination adjustment units are a first inclination adjustment unit of a first thickness and a second inclination adjustment unit of a second thickness.

3. The fastener structure configured to be locked slantingly as claimed in claim 2, wherein the first inclination adjustment unit is adjacent to the inserting end portion, the second inclination adjustment unit is adjacent to the terminal portion, and the first thickness of the first inclination adjustment unit is less than or equal to the second thickness of the second inclination adjustment unit.

4. The fastener structure configured to be locked slantingly as claimed in claim 1, wherein the at least two inclination adjustment units are a first inclination adjustment unit having a first coverage area and a second inclination adjustment unit having a second coverage area.

5. The fastener structure configured to be locked slantingly as claimed in claim 4, wherein the first inclination adjustment unit is adjacent to the inserting end portion, the second inclination adjustment unit is adjacent to the terminal portion, and the first coverage area of the first inclination adjustment unit is less than or equal to the second coverage area of the second inclination adjustment unit.

6. The fastener structure configured to be locked slantingly as claimed in claim 1, wherein the terminal portion further has a polygonal recess.

7. The fastener structure configured to be locked slantingly as claimed in claim 1, wherein the terminal portion is further extended with a head portion.

8. The fastener structure configured to be locked slantingly as claimed in claim 1, wherein at least one of the at least two inclination adjustment units is a thermoplastic plastic element.

9. The fastener structure configured to be locked slantingly as claimed in claim 1, wherein at least one of the at least two inclination adjustment units is a thermosetting plastic element.

10. The fastener structure configured to be locked slantingly as claimed in claim 1, wherein the at least two inclination adjustment units are located symmetrically on a circumferential surface of the rod body.
